(19) United States
(12) Patent Application Publication
(10) Pub. No.: US 2012/0232977 A1
(43) Pub. Date: Sep. 13, 2012

(54) REAL-TIME VIDEO IMAGE ANALYSIS FOR PROVIDING TARGETED OFFERS

(75) Inventors: Matthew A. Calman, Charlotte, NC (US); Erik Stephen Ross, Charlotte, NC (US); Alfred Hamilton, Charlotte, NC (US)

(73) Assignee: BANK OF AMERICA CORPORATION, Charlotte, NC (US)

(21) Appl. No.: 13/342,044

(22) Filed: Jan. 1, 2012

Related U.S. Application Data
(60) Provisional application No. 61/450,213, filed on Mar. 8, 2011.
(60) Provisional application No. 61/478,394, filed on Apr. 22, 2011.

(51) Int. Cl. G06Q 30/02; G06Q 30/06

(52) U.S. Cl. 705/14.25; 705/14.1

(57) ABSTRACT

System, method, and computer program product are provided for using real-time video analysis, such as augmented reality or the like to assist the user of mobile devices with selecting products or business through the use of targeted offers. Through the use of real-time vision object recognition objects, logos, artwork, products, locations, and other features that can be recognized in the real-time video stream can be matched to data associated with such to assist the user with selecting products and business. Targeted offers for product and business selection may be based on the financial behavior, pre-selected favorites, or recommendations of the user, individuals associated with the user, or other individuals. This invention allows a user to make a purchase at a point-of-sale and have confidence that the product or service purchased is the proper one to fit the user's needs.

### CLAIM OF PRIORITY UNDER 35 U.S.C. §119

This Non-provisional Patent Application claims priority to U.S. Provisional Patent Application Ser. No. 61/450,213, filed Mar. 8, 2011, entitled “Real-Time Video Image Analysis Applications for Commerce Activity,” and U.S. Provisional Patent Application Ser. No. 61/478,394 titled “Real-Time Video Image Analysis for Providing Targeted Offers” filed on Apr. 22, 2011, assigned to the assignee hereof and hereby expressly incorporated by reference herein.

### BACKGROUND

Individuals typically have a variety of choices when selecting a product. For example, if the individual is selecting a laundry detergent at a retail store, the retail store typically has several aisles of laundry detergents. The individual may select a particular laundry detergent that he/she historically selected when he/she has previously purchased laundry detergent, without giving serious consideration to other detergent choices available.

Many factors may play a role in an individual's selection of a particular brand of a product. The individuals perception of the brand, past use of the product of that brand, advertisement of the brand, offers for discounts for the brand, attributes such as convenience of the brand, etc., may all have a direct correlation with which brand of product an individual may select to purchase.

Today, modern handheld mobile devices, such as smart phones or the like, have the capability to facilitate payment for a cup of coffee or provide a boarding pass for a flight. These advances combine multiple technologies through a handheld mobile device to provide a user with an array of capabilities. For example, many smart phones are equipped with significant processing power, sophisticated multi-tasking operating systems, and high-bandwidth Internet connection capabilities. Moreover, such mobile devices often have addition features that are becoming increasing more common and standardized features. Such features include, but are not limited to, location-determining devices, such as Global Positioning System (GPS) devices; sensor devices, such as accelerometers; and high-resolution video cameras.

As the capabilities of such mobile devices have increased, so too have the applications (i.e., software) that rely can be used with the mobile devices. One such example of innovative software is a category known as augmented reality (“AR”), or more generally referred to as mediated reality. One such example of an AR presentment application platform is Layar, available from Layar, Amsterdam, the Netherlands. The Layar platform technology analyzes location data, compass direction data, and the like in combination with information related to the objects, locations or the like in the video stream to create browse-able “hot-spots” or “tags” that are superimposed on the mobile device display, resulting in an experience described as “reality browsing.”

Even with these advances in technology, the factors that determine an individual's selection of one brand of product over another brand typically involves no technological factors. Further, an individual may not know the qualities of products other than the products he/she has previously purchases or products having promotions. These promotions may include purchase restrictions that limit the benefits at different times, on different products, or at different merchants, etc. Unfortunately, the individual often selects a product based on past use or advertisement rather than the qualities of the product or qualities of a product that a friend finds appealing.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatuses (e.g., a system, computer program product and/or other devices) and methods for using real-time video analysis, such as AR or the like to assist the user of mobile devices with selecting products, which may allow a user to select a product or brand of product based on financial behaviors, pre-selected favorites, and/or recommendations of individuals associated with the user for the product.

Using real-time video analysis, such as augmented reality or the like to provide the user of mobile device a targeted offer. A targeted offer may provide the user a product recommendation based on financial behavior, pre-selected favorites of the user and/or others recommendations. In this way, a user may select new products, which may be similar to products that he/she or individuals associated with him/her have used and enjoyed in the past. Through the use of real-time vision object recognition, objects, logos, artwork, products, locations, and other features that can be recognized in the real-time video stream can be matched to data associated with products or businesses the user and/or individuals associated with the user have liked in the past. In some embodiments, the data that is matched to the images in the real-time video stream is specific to financial institutions, such as user financial behavior history, user purchase power, transaction history, and/or the like. In this regard, many of the embodiments herein disclosed leverage financial institution data, which is uniquely specific to financial institution, in providing information to mobile device users in connection with real-time video stream analysis.

In some embodiments, the data may be matched to a directory containing data about a user's financial behavior. In other embodiments, the data may be matched to a directory containing data about a user's pre-selected favorites. In yet other embodiments, the data may be matched to a directory containing product recommendations from individuals associated with the user or others. Once the data supplied by the images in the real-time video stream specific to the user mobile device is matched to data within the directory, an indicator is presented to the user mobile device display. For example, a user may provide an image in the real-time video stream of an aisle of a retail store. The data from the products within the aisle of the retail store is matched to the directory. At this point, an indicator is provided to the user indicating financial behavior, pre-selected favorites, and/or recommendations from individuals associated with the user for the products in the aisle. In some embodiments, the user is also provided special offers for the product, special offers for competing products or brands of products, or a special offer for a similar product from a competing retail store. The alternative products offered may be similar to the product selected by the user, but the competing product vendor or manufacturer may be a commercial partner of the financial institution providing the service.

One or more indicators are presented on the display of the mobile device in conjunction with the real-time video stream. Each of the indicators corresponds with an image of a product or business in which the individual might be interested. The product or business may be a product, service, or brand purchased in a prior transaction by the user or individual associated with the user, a pre-selected favorite of the user, or a product recommended by an individual associated with the user. The indicator may take various forms, such as a display of a tag, a highlighted area, a hot-spot, and/or the like. In some embodiments, the indicator is a selectable indicator, such that the user may select (e.g., click-on, hover-over, touch the display, provide a voice command, etc.) the product or indicator to provide display of specific information related to the product in which the user is interested, including at least one indication of user or individual associated with user financial behavior, pre-selected favorites, and/or individuals associated with the user recommendations for similar or alternative products. In other embodiments, the indicator itself may provide the information or a portion of the information, without user selection. For example, a user may wish to purchase a television; the user may use real-time vision object recognition to recognize the television within an aisle of a retail store. The real-time vision object recognition may consider the located at a specific retail store, the characteristics of the television such as brand, quality, etc., and price of the television. The user may select the indicator. The selected indicator may display recommendations, friends or others, based on social network indicators, where individuals may recommend or comment regarding the television the user may select for purchase. In another example, a user may wish to purchase an item at a retail store that his/her significant other generally purchases. In order to select the proper product, the real-time vision object recognition may consider the products of the aisle and compare them to data from the user's transaction history to determine the specific product (including brand, type, etc.) that his/her significant other generally purchases. In this way, he/she may select the proper product that his/her significant other normally purchases.

Along with providing financial behavior, pre-selected favorites, and/or others recommendations, the display of the real-time video stream on a mobile device may also provide the user with special offers for products. In some embodiments, the special offers may be for products of a brand the user may request. In some embodiments, the special offers may be for products of competing brands. In some embodiments, the special offers may be for products from the retailer where the user is using the real-time video stream. In yet other embodiments, the special offer may be for a competing retailer. Special offers may be in the form of a discount, coupon, etc. that may expire within a predetermined amount of time or may be available to the user at any time he/she wishes to make a transaction. The special offers may also be contingent on opening accounts or other lines of business with the financial institution, independent of the transaction.

Embodiments of the present invention provide a targeted offer for a product or service. The product or business targeted offer may be based on financial behavior, pre-selected favorites, and/or recommendations for the user or individuals associated with the user. Financial behavior, pre-selected favorites, and/or recommendations for the user or individuals associated with the user may be matched to data in a directory to provide the user real-time selection criteria for products or business in a real-time video stream.

Individuals associated with user may be determined by accessing a social network, friends of the user, the contact list on the mobile device, a listing of individuals provided by the user, family members of the user, work collogues, club members, or the like.

In some embodiments, the financial behavior of the user and/or individuals associated with the user may be provided via an indicator. Financial behavior may be determined base on criteria such as, but not limited to, spending/transaction history, including products acquired; amount spent on products; businesses at which products were acquired; amount spent at specific businesses; how recently products were acquired; how recently a business was used to make a purchase/transaction; spending/transaction patterns, such as time of date/week/month/year for making purchases/transactions; offers used to make purchases/transactions; and the like. The financial behavior data may be determined based on credit, debit, and other demand deposit account purchases/transactions, financial intuitions or the like are in a unique position to have such financial behavior data at their disposal.

Pre-selected favorites may include favorites of the user or individuals associated with the user. In some embodiments, pre-selected favorites may be provided to the directory by the user or individual associated with the user by interface. The interface may be provided from a financial institution to the mobile device of the user or individual associated with the user. The interface may also be provided from a financial institution to the user or individuals associated with the user through online banking means. The user or individual associated with the user may access the interface in any means he/she would typically access online banking. In this way, the user or individuals associated with the user may provide favorites at any time they have access to online banking. Pre-selected favorites may also be provided by the user or individuals associated with the user by social networks. In this way, the individual may provide a list of products or business he/she recommends on his/her social network page.

Recommendations may be provided by individuals associated with the user or other individuals. Recommendations may be comments, ranking of the product, reviews of the product, etc. In some embodiments, recommendations may be provided by individuals associated with the user or other individuals not associated with the user. Recommendations may be provided via social networking sites, via web-sites that provide reviews and/or comments for individuals who have used the products, via messaging, such as text or voice messaging, etc. In this way, the directory may pull comments from other individuals, known or not known to the user, in order for the user to have a recommendation regarding the products in the real-time video stream if the user so desires.

The targeted offers program may further provide special offers for familiar business, familiar products, competing business, or competing products. Special offers may be in the form of a discount, coupon, etc. that may expire within a predetermined amount of time or may be available to the user at any time he/she wishes to make a transaction. The special offers may also be contingent on opening accounts or other lines of business with the financial institution, independent of the transaction.

Embodiments of the invention relate to systems, methods, and computer program products for providing offers that are associated with products, comprising: building a directory of data relating to products, the directory further comprising data relating to user product preferences, previous product purchases, and/or product recommendations; identifying one or more products proximate in location to a mobile device; recognizing the one or more products proximate in location to the mobile device as a products in the directory; matching the recognized one or more products with offers associated with the product; and presenting, via the mobile device of the user, an indicator associated with the product based on the recognition of the one or more products within the directory.

In some embodiments, the directory comprises manually inputted list data, wherein the list data indicates user products preferences. Previous product purchases are provided by financial institution recognition of user purchase history.

In some embodiments, identifying products further comprises capturing, via the mobile device, images of the one or more products. Capturing images further comprises implementing object recognition processing to identify one or more images that correspond to one or more products. Identifying products may further comprise capturing real-time imaging of the one or more products. Identifying products may further comprise determining a location of the mobile device and determining, the one or more products based on the determined location.

In some embodiments, presenting an indicator associated with the product comprises displaying the indicator on a display of the mobile device. Presenting an indicator associated with the product may further comprise superimposing the indicator over real-time video that is captured by the mobile device. In some embodiments, the indicator is selectable by the user.

In some embodiments, the indicator, upon being selected, provides recognition of a product based on the directory wherein the directory is based at least in part on products the user has previous purchases. In some embodiments, the indicator, upon being selected, provides recognition of a product based on the directory wherein the directory is based at least in part on manually inputted user product preferences. In other embodiments, the indicator, upon being selected, provides a promotional offer for purchase of the product.

In some embodiments, the invention may further comprise determining whether the mobile device is capturing a real-time video stream comprising a depiction of the product prior to presenting the indicator associated with the product.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a high level process flow illustrating a real-time targeted offer process, in accordance with one embodiment of the present invention;

FIG. 2 provides a targeted offer determination system environment, in accordance with an embodiment of the invention;

FIG. 3 provides a block diagram illustrating a mobile device, in accordance with an embodiment of the invention;

FIG. 4 provides a representation illustrating a mobile device real-time video stream display environment, in accordance with an embodiment of the invention;

FIG. 5 provides a process map for a providing a targeted offer, in accordance with an embodiment of the invention;

FIG. 6 provides a process map for the analysis of selecting targeted offers, in accordance with an embodiment of the invention; and

FIG. 7 provides a selection interface, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that offer payment account systems to users.

While embodiments discussed herein are generally described with respect to “real-time video streams” or “real-time video” it will be appreciated that the video stream may be captured and stored for later viewing and analysis. Indeed, in some embodiments, video is recorded and stored on a mobile device and portions or the entirety of the video may be analyzed at a later time. The later analysis may be conducted on the mobile device or loaded onto a different device for analysis. The portions of the video that may be stored and analyzed may range from a single frame of video (e.g., a screenshot) to the entirety of the video. Additionally, rather than video, the user may opt to take a still picture of the environment to be analyzed immediately or at a later time. Embodiments in which real-time video, recorded video or still pictures are analyzed are contemplated herein.

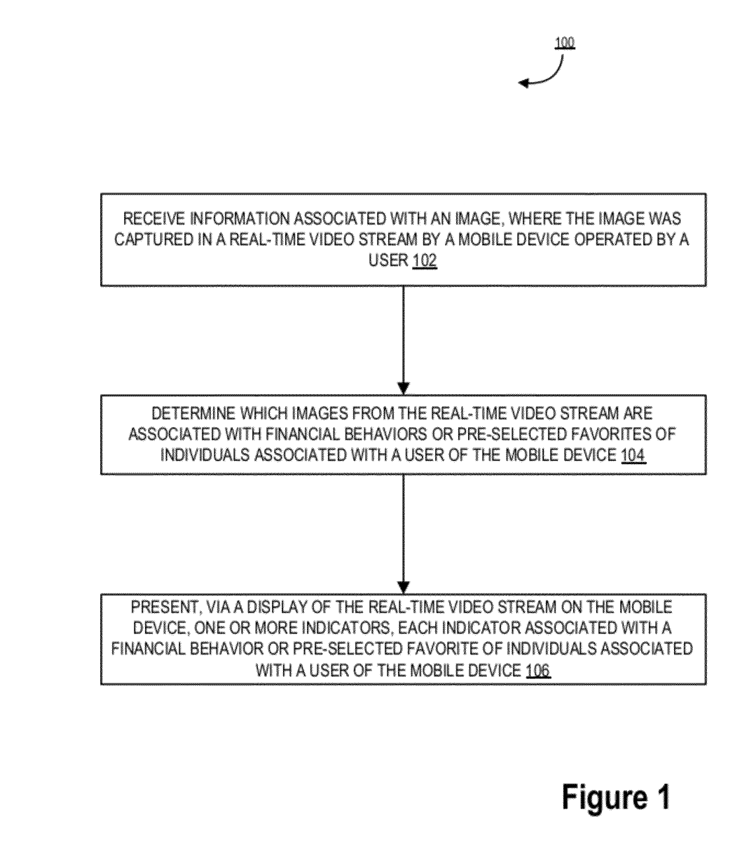

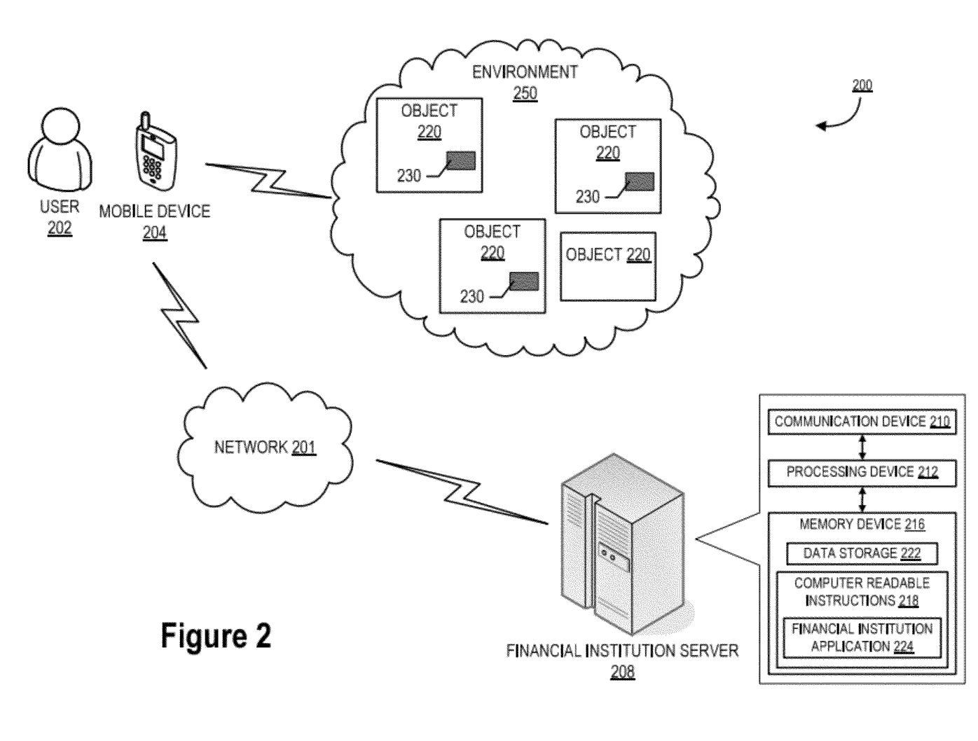

FIG. 1 illustrates a high level process flow of a real-time targeted offer process 100, which will be discussed in further detail throughout this specification with respect to FIGS. 2 through 7. The first step in the targeted offer process 100 is to receive information associated with an image, where the image was captured by a mobile device using real-time video stream, the mobile device operated by a user, as illustrated by block 102. A real-time video stream may include images of products, businesses, or the like. For example, a user may move about an aisle within a retail location while capturing a real-time video stream of the environment including the products on the selves in the aisle. In another embodiment of the invention, a user may move about a city street or shopping mall while capturing a real-time video stream of the environment including the businesses located on the street or within the mall. In additional embodiments, the real-time video stream may be captured from a mobile device affixed to a moving vehicle, such as an automobile or the like, such that as the vehicle is driven, real-time video stream may be captured including images of the businesses that the vehicle passes.

Next, in block 104 a determination is made as to which images from the real-time video stream are associated with products, business, or the like that are aligned with financial behaviors, pre-selected favorites, or recommendations of users or individuals associated with the users of a mobile device. The determination is made by analyzing the real-time video stream for objects, logos, artwork, and/or other product-indicating features or business-indications features to determine what the products are within the video stream and to then provide matches (i.e., associations) for the products or business based on the financial behavior, pre-selected favorites, or recommendations of users or individual associated with the user of the mobile device. The individuals associated with the user may be determined by accessing a social network, the contact listing on the mobile device, a listing of individuals provided by the user, family members of the user, or the like.

Thereafter, at block 106 one or more indicators are presented on the display of the mobile device in conjunction with the real-time video stream. Each of the indicators are associated with an image determined to be a product or business associated with the financial behavior, pre-selected favorite, or recommendation of the user or individual associated with the user of the mobile device. The indicator may take various forms, such as display of a tag, a highlighted area, a hot-spot, or the like. In specific embodiments, the indicator is a selectable indicator, such that a user may select (e.g., click-on, hover-over, touch the display, provide a voice command, and/or the like) the product, business logo, or indicator to provide display of specifics related to the product, business, or offer associated with the product or business. In some embodiments, the indicator itself may provide the information or a portion of the information to the user. In addition, the information related to the product or business may include a review of the product or business by the associated individual. In additional embodiments, the method may include sending a communication via email, text, voice message, video message/conference or the like, requesting a review, an updated review and/or a quality rating for the product and/or business.

FIG. 2 provides a targeted offer determination system environment 200, in accordance with one embodiment of the present invention. As illustrated in FIG. 2, the financial institution server 208 is operatively coupled, via a network 201 to the mobile device 204. In this way, the financial institution server 208 can send information to and receive information from the mobile device 204, to associate indicators within the real-time video stream to provide financial behavior, pre-selected favorites, or recommendation data to the user. FIG. 2 illustrates only one example of an embodiment of a targeted offer determination system environment 200, and it will be appreciated that in other embodiments one or more of the systems, devices, or servers may be combined into a single system, device, or server, or be made up of multiple systems, devices, or servers.

The network 201 may be a global area network (GAN), such as the Internet, a wide area network (WAN), a local area network (LAN), or any other type of network or combination of networks. The network 201 may provide for wireline, wireless, or a combination wireline and wireless communication between devices on the network.

In some embodiments, the user 202 is an individual. The user 202 may be at a retail store, near a business center, a city street, a shopping mail, and/or within real-time video range of any product and/or business for which the user 202 may wish to consider a transaction. The transaction may be made by the user 202 using the mobile device 204, such as a mobile wallet (i.e. smart phone, PDA, etc.) or other types of payment options, such as credit cards, checks, cash, debit cards, loans, lines of credit, virtual currency, etc. that allow the user 202 to make a transaction to purchase the good, service, etc.

As illustrated in FIG. 2, the financial institution server 208 generally comprises a communication device 210, a processing device 212, and a memory device 216. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 212 is operatively coupled to the communication device 210 and the memory device 216. The processing device 212 uses the communication device 210 to communicate with the network 201 and other devices on the network 201, such as, but not limited to the mobile device 204. As such, the communication device 210 generally comprises a modem, server, or other device for communicating with other devices on the network 201.

In some embodiments, the processing device 212 may also be capable of operating one or more applications, such as one or more applications functioning as an artificial intelligence (“AI”) engine. The processing device 212 may recognize objects that it has identified in prior uses by way of the AI engine. In this way, the processing device 212 may recognize specific objects and/or classes of objects, and store information related to the recognized objects in one or more memories and/or databases discussed herein. Once the AI engine has thereby “learned” of an object and/or class of objects, the AI engine may run concurrently with and/or collaborate with other modules or applications described herein to perform the various steps of the methods discussed. For example, in some embodiments, the AI engine recognizes an object that has been recognized before and stored by the AI engine. The AI engine may then communicate to another application or module of the mobile device 204 and/or server, an indication that the object may be the same object previously recognized. In this regard, the AI engine may provide a baseline or starting point from which to determine the nature of the object. In other embodiments, the AI engine's recognition of an object is accepted as the final recognition of the object.

As further illustrated in FIG. 2, the financial institution server 208 comprises computer-readable instructions 218 stored in the memory device 216, which in one embodiment includes the computer-readable instructions 218 of a financial institution application 224. In some embodiments, the memory device 216 includes data storage 222 for storing data related to targeted offers including but not limited to data created and/or used by the financial institution application 224 or a directory, including financial behavior, pre-selected favorites, recommendations, or special offers for consideration by the user 202.

In the embodiment illustrated in FIG. 2 and described throughout much of this specification, the financial institution application 224 may provide access to a directory storing pre-selected favorites, financial behavior, recommendations, or special offers. In some embodiments, the financial institution application 224 allows the user 202 and individuals associated with the user 202 to manually input, via a mobile device 204 or other device with similar processing features such as a computer, tablet, hand held device, etc. The user 202 or individuals associated with the user 202 may input pre-selected favorite goods or services for consideration or input recommendations on social networking sites or other review sites. The pre-selected favorites may be added through an interface, social networking, etc. In this way, the user 202 may provide pre-selected favorites by several means, thus allowing for easy accessibility to update a user's or individual associated with the user's pre-selected favorites. For example, a husband may get a grocery list from his wife. The wife may update her pre-selected favorites for the husband to use at the store. In this way, the wife may not have to provide the husband with an exact list of products, but instead provide the list of products to the system. The husband may go to the grocery story and using the real-time video stream, determine the exact products that his wife may have requested. The system may identify the products as the husband moves through the store. In this way, the system may recommend the optimal path through the store to maximize efficiency or user defined goals. User 202 defined goals may include, but are not limited to speed, specific products to get first, specific products to get last, etc. The pre-selected favorites may be pre-programmed by the user 202 as application preferences, so that the mobile device 204 may provide the pre-selected favorites to the user 202. In one example, the processing device 310 of the mobile device 204 allows the user 202 to communicate, to products that he/she may wish to purchase in the future (i.e. a watch list), such as a list of items at a grocery store to the financial institution application 224. The data stored within the financial institution application 224 provides computer readable instructions 218 to the processing device 212 to allow for selection of these products during use in an environment 250. The financial institution application 224 stores the pre-selected favorites for use by the user 202 or individuals associated with the user 202 when a real-time video stream indicator is available.

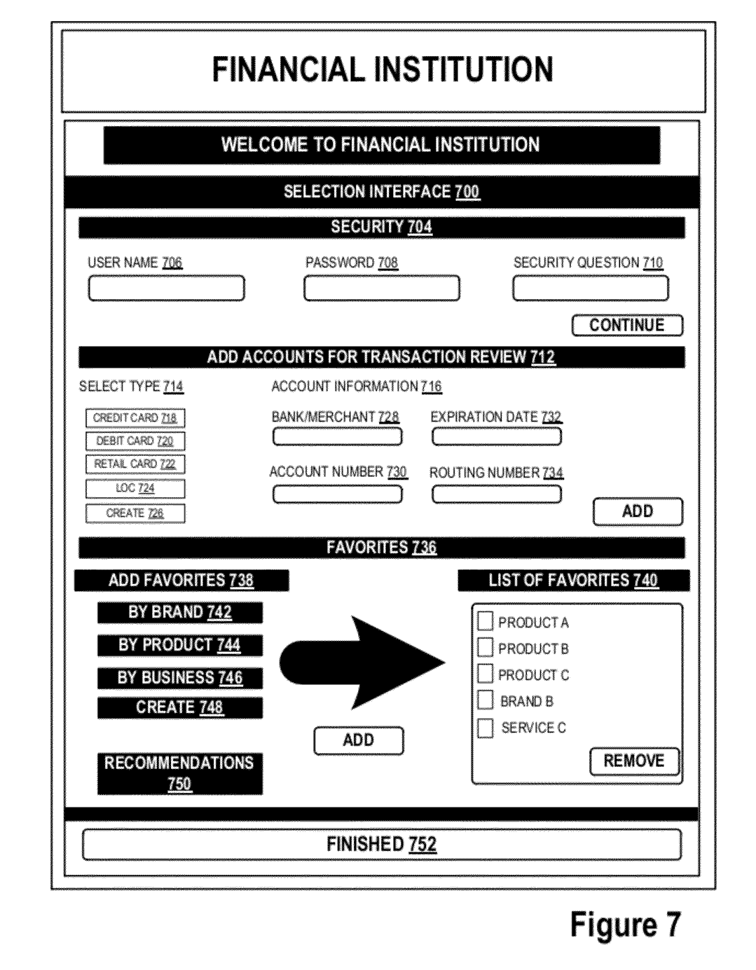

In some embodiments, as explained in further detail below pre-selected favorites may include favorites of the user 202 or individuals associated with the user. In one embodiment, pre-selected favorites may be provided to the directory by the user 202 or individual associated with the user 202 by an interface, such as that described in further detail below with respect to FIG. 7. The interface may be provided from a financial institution to the mobile device 204 of the user 202 or individual associated with the user 202. The interface may also be provided from a financial institution to the user 202 or individuals associated with the user 202 through online banking means. The user 202 or individual associated with the user 202 may access the interface in any means he/she would typically access online banking. In this way, the user 202 or individuals associated with the user 202 may provide favorites at any time they have access to online banking. Pre-selected favorites may also be provided by the user 202 or individuals associated with the user 202 by social networks. In this way, the individual may provide a list of products or business he/she recommends on his/her social network page.

In some embodiments, as explained in further detail below, the financial behavior of the user 202 or individuals associated with the user 202 may also be stored within the financial institution application 224, such that the user 202 may be provided an indicator as to which goods or services he/she or his/her associates have purchased, during a real-time video stream. For example, an individual associated with the user 202 may ask the user 202 to go to the store and buy food for a party. The user 202 may not know the food that is going to be served at the party. But using the individual associated with the user's recent financial behavior, the user 202 may be able to understand and or discern the specific types of potato chips, drinks, etc. that the individuals associated with the user 202 recently purchased. In this way, the user 202 may purchase more of the same food for the party or may select a different type of food for the party.

Financial behavior may constitute the financial behavior of the user 202 and/or individuals associated with the user 202. Financial behavior, as determined by the financial institution application 224, may be determined based on criteria such as, but not limited to spending/transaction history, including products acquired; amount spent on products; businesses at which products were acquired; amount spent at specific businesses; how recently products were acquired; how recently a business was used to make a purchase/transaction; spending/transaction patterns, such as time of date/week/month/year for making purchases/transactions; offers used to make purchases/transactions; and the like. The financial behavior data may be determined based on account demands for purchases/transactions, financial institutions or the like are in a unique position to have such financial behavior data at their disposal. In one embodiment, as explained in further detail below, the accounts available within the financial institution application 224 include all financial accounts available to the user 202. In some embodiments, the accounts available to the user 202 may include payment accounts that the user 202 has with a primary financial institution, a secondary financial institution, or business that the user 202 may use to make a transaction. For example, these payment accounts may include cash, check, credit cards, debit cards, retailer cards, wire transfers, ACH payments, online bill payment, and/or a plurality of lines of credit. In some embodiments, the types of accounts available to the user 202 may be stored in the memory device 216 of the financial institution server 208, because the user 202 may have a prior relationship and/or accounts with the financial institution. In other embodiments, the types of account available to the user 202 may be determined by accessing other financial institution computer systems.

In some embodiments, as explained in further detail below, recommendations of the user 202, individuals associated with the user 202, or other individuals may also be stored within the financial institution application 224, such that the user 202 may be provided an indicator as to which goods or services he/she, his/her associates, or others have purchased and liked or disliked, during a real-time video stream. For example, the financial institution application 224 may provide the user 202 with a review of the product, a customer review of the product from any web-site that may provide for user 202 comments or individuals associated with the user 202 comments. The comments from the individuals associated with the user 202 may be in the form of a sent communication such as an email, text message, voice message, video, online video chat with financial advisor, friend, social network, message/conference, or the like. For example, an individual associated with the user 202 may provide the user 202 an interactive voice message regarding the product of interest within an environment 250. Once the user 202 selects the indicator from the product, the individual associated with the user's voice may be provided in such a way for the user 202 to listen to the individual associated with the user's review audibly. In yet another example, a text message or email from the individual associated with the user 202 may instantly be displayed on the user 202 mobile device 204 if an indicator for a product is selected. In this way, the user 202 may have text recommendations, reviews, and/or feedback for the product.

The financial institution application 224 may further provide the user 202 on the display of a mobile device 204, special offers for products in the environment or similar competitor products. In some embodiments, the special offers may be for products of a brand the user 202 may request. In some embodiments, the special offers may be for products of competing brands. In some embodiments, the special offers may be for similar products of a competing retailer or business. Special offers may be in the form of a discount, coupon, etc. that may expire within a predetermined amount of time or may be available to the user 202 at any time he/she wishes to make a transaction. The special offers may also be contingent on opening accounts or other lines of business with the financial institution, independent of the transaction.

For example, financial behavior may indicate that the user 202 has purchased the same type of toothpaste for the last several years. The financial institution application 224 may provide a competitor brand tooth paste to the user 202 with a special offer, so that the user 202 may purchase a product different than his/her norm. In other embodiments, the financial institution application 224 may provide the user 202 a special offer based on his/her consistent purchase of that product, or brand loyalty. In yet other embodiments, the financial institution application 224 may provide the user 202 a special offer based on the manufacture's and/or merchant's commercial partnership with the financial institution. In yet other embodiments, the financial institution application 224 may be provided a wish list defined with automatic acceptance of specific predefined rules engines, such that when a targeted offer matches the predefined rules the financial institution application 224 may execute the purchase of and payment for the product, on behalf of the user 202.

In some embodiments, as described in further detail below, the financial institution application 224 may recognized a marker 230 and/or objects 220 within an environment 250. The marker 230 may be interpreted with respect to data in the memory device 216 and be recognized as a possible products and/or services that may be available to the user 202. In this way, the financial institution server 208 provides marker 230 interpretation and analysis with respect to the data on the financial institution server 208.

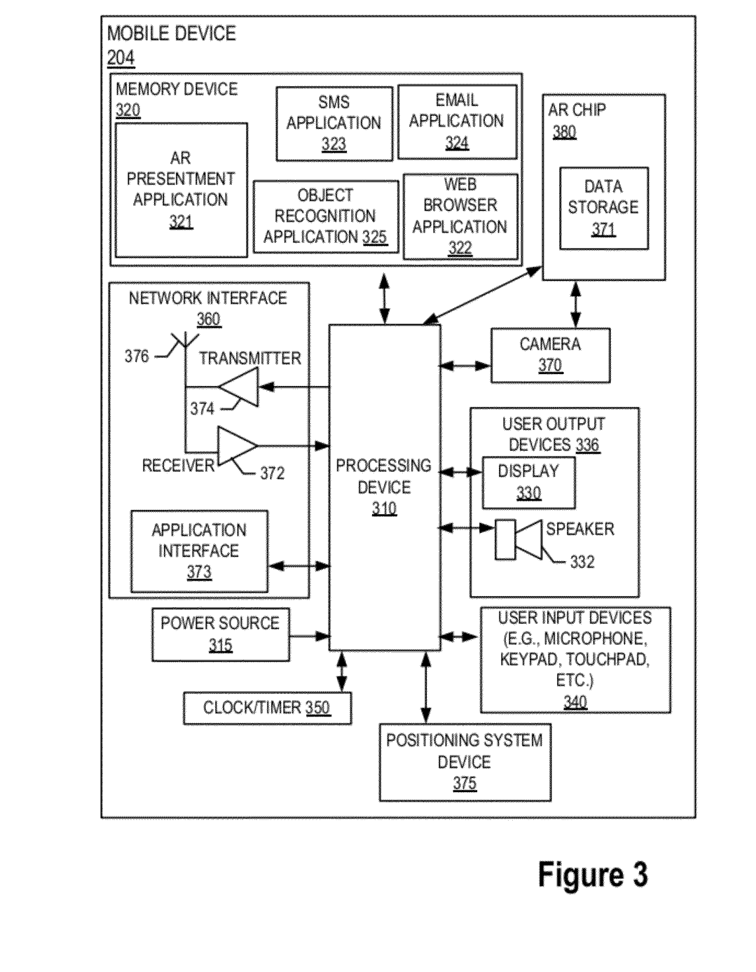

As further illustrated is FIG. 2, an environment 250 in which the user 202 utilizes a mobile device 204 to capture real-time video of an environment 250 in an augmented reality experience. As described in further detail below with respect to FIG. 3, the mobile device 204 may be any mobile communication device. The mobile device 204 has the capability of capturing real-time video of the surrounding environment 250. The real-time video capture may be by any means known in the art. In one particular embodiment, the mobile device 204 is a mobile telephone equipped with a camera capable of video capture.

The environment 250 contains a number of objects 220. Objects 220 include, but are not limited to goods or businesses the user 202 may wish to view a targeted offer for. For example, an object 220 may be a product, such as a television, vehicle, computer, etc. or an object 220 may be a business, such as a service, like a dry cleaner, pest control specialist, mechanics shop, etc. Some of such objects 220 may include a marker 230 identifiable to the mobile device 204. A marker 230 may be any type of marker that is a distinguishing feature that can be interpreted to identify specific objects 220. In some embodiments, the marker 230 may be interpreted by the mobile device 204. In other embodiments, the marker 230 may be interpreted by the financial institution server 208. In yet other embodiments, the marker 230 may be interpreted by both the mobile device 204 and the financial institution server 208. For instance, a marker 230 may be alpha-numeric characters, symbols, logos, shapes, ratio of size of one feature to another feature, a product identifying code such as a bar code, electromagnetic radiation such as radio waves (e.g., radio frequency identification (RFID)), architectural features, color, etc. In some embodiments, the marker 230 may be audio and the mobile device 204 may be capable of utilizing audio recognition to identify words or unique sounds broadcast. The marker 230 may be any size, shape, etc. Indeed, in some embodiments, the marker 230 may be very small relative to the object 220 such as the alpha-numeric characters that identify the name or model of an object 220, whereas, in other embodiments, the marker 230 is the entire object 220 such as the unique shape, size, structure, etc.

In some embodiments, the marker 230 is not actually a physical marker located on or being broadcast by the object 220. For instance, the marker 230 may be some type of identifiable feature that is an indication that the object 220 is nearby. In some embodiments, the marker 230 for an object 220 may actually be the marker 230 for a different object 220. For example, the mobile device 204 may recognize a particular building as being “Building A.” Data stored in the data storage 371 may indicate that “Building B” is located directly to the east and next to “Building A.” Thus, marker 230 for an object 220 that are not located on or being broadcast by the object 220 are generally based on fixed facts about the object 220 (e.g., “Building B” is next to “Building A”). However, it is not a requirement that such a marker 230 be such a fixed fact. The marker 230 may be anything that enables the mobile device 204 and/or the financial institution application 224 to interpret to a desired confidence level what the object is. For example, the mobile device 204, object recognition application 325 and/or AR presentation application 321 may be used to identify a particular person as a first character from a popular show, and thereafter utilize the information that the first character is nearby features of other characters to interpret that a second character, a third character, etc. are nearby, whereas without the identification of the first character, the features of the second and third characters may not have been used to identify the second and third characters. This example may also be applied to objects outside of people.

The marker 230 may also be, or include, social network data, such as data retrieved or communicated from the Internet, such as tweets, blog posts, social networking site posts, various types of messages and/or the like. In other embodiments, the marker 230 is provided in addition to social network data as mentioned above. For example, mobile device 204 may capture a video stream and/or one or more still shots of a large gathering of people. In this example, as above, one or more people dressed as characters in costumes may be present at a specified location. The mobile device 204, object recognition application 325, and/or the AR presentation application 321 may identify several social network indicators, such as posts, blogs, tweets, messages, and/or the like indicating the presence of one or more of the characters at the specified location. In this way, the mobile device 204 and associated applications may communicate information regarding the social media communications to the user and/or use the information regarding the social media communications in conjunction with other methods of object recognition. For example, the mobile device 204 object recognition application 325, and/or the AR presentation application 321 performing recognition of the characters at the specified location may confirm that the characters being identified are in fact the correct characters based on the retrieved social media communications. This example may also be applied objects outside of people.

In some embodiments, the mobile device 204 and/or server accesses one or more other servers, social media networks, applications and/or the like in order to retrieve and/or search for information useful in performing an object recognition. In some embodiments, the mobile device 204 and/or server accesses another application by way of an application programming interface or API. In this regard, the mobile device and/or server may quickly search and/or retrieve information from the other program without requiring additional authentication steps or other gateway steps.

In some embodiments, markers 230 may be recognized by the financial institution application 224. For example, the financial institution application 224 may identify a markers 230 as being a specific television, the financial institution application 224 may then provide real-time data indicating the user 202 or individuals associated with the user's financial behavior, such as television brands they have purchased in the past; pre-selected favorites, such as television brands, sizes, or types that they are wishing to purchase; recommendations from individuals associated with the user 202 or others who have purchased that television or similar versions of that television and their comments regarding it; and/or special offers relating to that television or similar competitor televisions based on the recognition of the markers 230 to the user 202 via a mobile device 204.

While FIG. 2 illustrates that the objects 220 with markers 230 only include a single marker 230, it will be appreciated that the object 220 may have any number of markers 230 with each equally capable of identifying the object 220. Similarly, multiple markers 230 may be identified by the mobile device 204 such that the combination of the markers 230 may be utilized to identify the object 220. For example, the facial recognition may identify a person as a famous athlete, and thereafter utilize the uniform the person is wearing to confirm that it is in fact the famous athlete.

In some embodiments, a marker 230 may be the location of the object 220. In such embodiments, the mobile device 204 may utilize GPS software to determine the location of the user 202. As noted above, a location-based markers 230 could be utilized in conjunction with other non-location-based markers 230 identifiable and recognized by the mobile device 204 to identify the object 220. However, in some embodiments, a location-based markers 230 may be the only markers 230. For instance, in such embodiments, the mobile device 204 may utilize GPS software to determine the location of the user 202 and a compass device or software to determine what direction the mobile device 204 is facing in order to identify the object 220. In still further embodiments, the mobile device 204 does not utilize any GPS data in the identification. In such embodiments, markers 230 utilized to identify the object 220 are not location-based.

FIG. 3 illustrates an embodiment of a mobile device 204 that may be configured to execute augmented reality functionality. A “mobile device” 204 may be any mobile communication device, such as a cellular telecommunications device (i.e., a cell phone or mobile phone), personal digital assistant (PDA), a mobile Internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like.

The mobile device 204 may generally include a processing device 310 communicably coupled to such devices as a memory device 320, user output devices 336, user input devices 340, a network interface 360, a power source 315, a clock or other timer 350, a camera 370, a positioning system device 375, one or more Chips 380, etc.

In some embodiments, the mobile device 204 and/or the server access one or more databases or datastores (not shown) to search for and/or retrieve information related to the object and/or marker. In some embodiments, the mobile device 204 and/or the server access one or more datastores local to the mobile device 204 and/or server and in other embodiments, the mobile device 204 and/or server access datastores remote to the mobile device and/or server. In some embodiments, the mobile device 204 and/or server access both a memory and/or datastore local to the mobile device 204 and/or server as well as a datastore remote from the mobile device 204 and/or server.

The processing device 310 may include functionality to operate one or more software programs or applications, which may be stored in the memory device 320. For example, the processing device 310 may be capable of operating a connectivity program, such as a web browser application 322. The web browser application 322 may then allow the mobile device 204 to transmit and receive web content, such as, for example, location-based content and/or other web page content, according to a Wireless Application Protocol (WAP), Hypertext Transfer Protocol (HTTP), and/or the like.

The processing device 310 may also be capable of operating applications, such as an object recognition application 325 and/or an AR presentment application 321. The object recognition application 325 and/or AR presentment application 321 may be downloaded from a server and stored in the memory device 320 of the mobile device 204. Alternatively, the object recognition application 325 and/or AR presentment application 321 may be pre-installed and stored in a memory in the chip 380. In such an embodiment, the user 202 may not need to download the object recognition application 325 and/or AR presentment application 321 from a server. In this way the object recognition application 325 and/or AR presentment application 321 may remain at the server, such as the financial institution server 208, within the financial institution application 224.

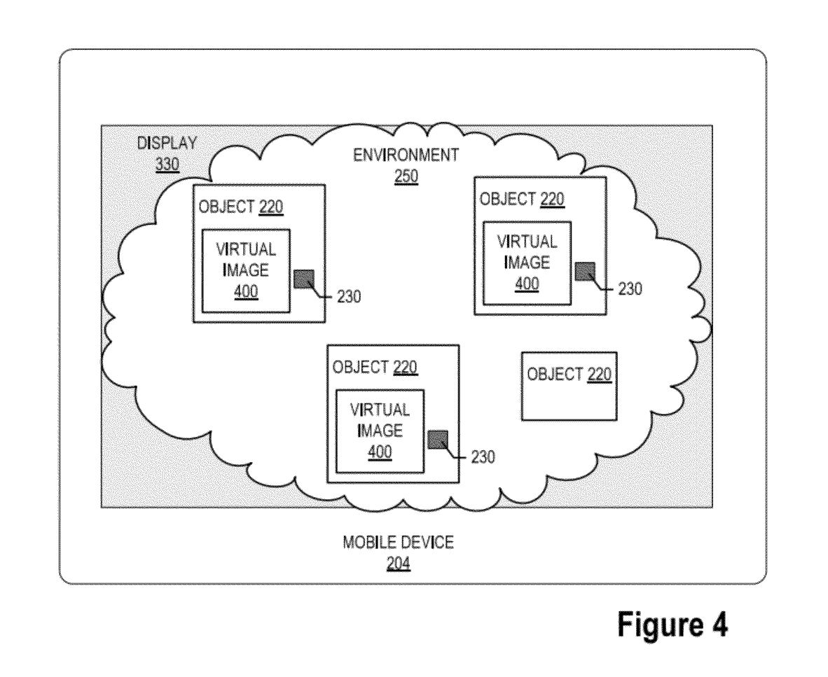

The object recognition application 325 provides the mobile device 204 with object recognition capabilities. In this way, objects 220 such as products and/or the like may be recognized by the object 220 itself and/or markers 230 associated with the objects 220. This is described in further detail below with respect to FIG. 4. In this way the object recognition application 325 may communicate with other devices on the network 201 to determine the object 220 within the real-time video stream.

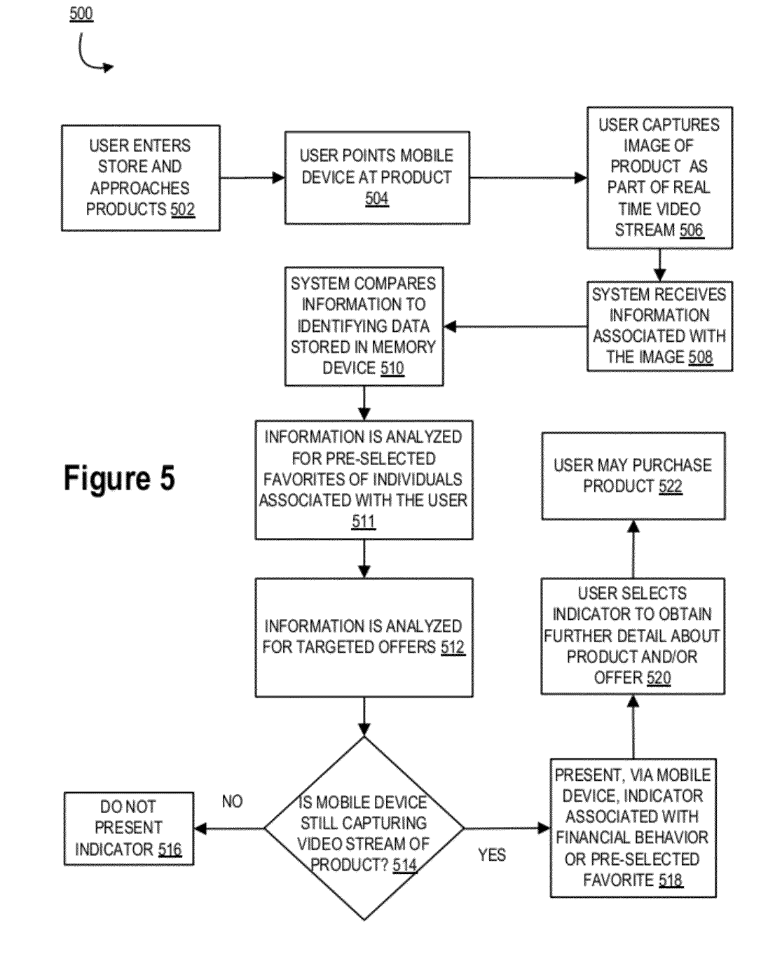

The AR presentment application 321 provides the mobile device 204 with AR capabilities. In this way, the AR presentment application 321 may provide superimposed indicators related to the object 220 in the real-time video stream, such that the user 202 may have access to the targeted offers by selecting an indicator superimposed on the real-time video stream. The AR presentment application 321 may communicate with the other devices on the network 201 to provide the user 202 with indications associated with targeted offers for objects 202 in the real-time video display. The presentation and selection of indicators provided to the user 202 via the AR presentment application 321 is described in further detail below with respect to FIG. 5.

The chip 380 may include the necessary circuitry to provide object recognition and AR functionality to the mobile device 204. Generally, the chip 380 will include data storage 371 which may include data associated with the objects 220 within a real-time video stream that the object recognition application 325 identifies as having a certain marker(s). The chip 380 and/or data storage 371 may be an integrated circuit, a microprocessor, a system-on-a-chip, a microcontroller, or the like. As discussed above, in one embodiment, the chip 380 may also provide the AR functionality to the mobile device 204. In this way, the chip 308 will included data storage 371 which may include data associated with the AR presentment application 321.

Of note, while FIG. 3 illustrates the chip 380 as a separate and distinct element within the mobile device 204, it will be apparent to those skilled in the art that the chip 380 functionality may be incorporated within other elements in the mobile device 204. For instance, the functionality of the chip 380 may be incorporated within the memory device 320 and/or the processing device 310. In a particular embodiment, the functionality of the chip 380 is incorporated in an element within the mobile device 204 that provide object recognition and/or AR capabilities to the mobile device 204. Still further, the chip 380 functionality may be included in a removable storage device such as an SD card or the like.

The processing device 310 may be configured to use the network interface 360 to communicate with one or more other devices on a network 201 such as, but not limited to the financial institution server 208. In this regard, the network interface 360 may include an antenna 376 operatively coupled to a transmitter 374 and a receiver 372 (together a “transceiver”). The processing device 310 may be configured to provide signals to and receive signals from the transmitter 374 and receiver 372, respectively. The signals may include signaling information in accordance with the air interface standard of the applicable cellular system of the wireless telephone network that may be part of the network 201. In this regard, the mobile device 204 may be configured to operate with one or more air interface standards, communication protocols, modulation types, and access types. By way of illustration, the mobile device 204 may be configured to operate in accordance with any of a number of first, second, third, and/or fourth-generation communication protocols and/or the like. For example, the mobile device 204 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 204 may also be configured to operate in accordance with non-cellular communication mechanisms, such as via a wireless local area network (WLAN) or other communication/data networks.

The network interface 360 may also include an application interface 373 in order to allow a user 202 to execute some or all of the above-described processes with respect to the AR presentment application 321 and/or the chip 380. In some embodiments, the objects recognized by the object recognition application 325 may be provided in an augmented reality setting, such that indicators associated with the objects 220 in the real-time video stream. In some embodiments, the application interface 373 may further execute some or all of the above-described processes with respect to the financial institution application 224 associated with the presentment of indicators in an augmented reality setting. The application interface 373 may have access to the hardware, e.g., the transceiver, and software previously described with respect to the network interface 360. Furthermore, the application interface 373 may have the ability to connect to and communicate with an external data storage on a separate system within the network 201. In some embodiments, the external data is stored in the memory device 216 of the financial institution server 208.

As described above, the mobile device 204 may have a user interface that includes user output devices 336 and/or user input devices 340. The user output devices 336 may include a display 330 (e.g., a liquid crystal display (LCD) or the like) and a speaker 332 or other audio device, which are operatively coupled to the processing device 310. The user input devices 340, which may allow the mobile device 204 to receive data from a user 202, may include any of a number of devices allowing the mobile device 204 to receive data from a user 202, such as a keypad, keyboard, touch-screen, touchpad, microphone, mouse, joystick, other pointer device, button, soft key, and/or other input device(s).

The mobile device 204 may further include a power source 315. Generally, the power source 315 is a device that supplies electrical energy to an electrical load. In some embodiment, power source 315 may convert a form of energy such as solar energy, chemical energy, mechanical energy, etc. to electrical energy. Generally, the power source 315 in a mobile device 204 may be a battery, such as a lithium battery, a nickel-metal hydride battery, or the like, that is used for powering various circuits, e.g., the transceiver circuit, and other devices that are used to operate the mobile device 204. Alternatively, the power source 315 may be a power adapter that can connect a power supply from a power outlet to the mobile device 204. In such embodiments, a power adapter may be classified as a power source “in” the mobile device 204.

The mobile device 204 may also include a memory device 320 operatively coupled to the processing device 310. As used herein, memory may include any computer readable medium configured to store data, code, or other information. The memory device 320 may include volatile memory, such as volatile Random Access Memory (RAM) including a cache area for the temporary storage of data. The memory device 320 may also include non-volatile memory, which can be embedded and/or may be removable. The non-volatile memory may additionally or alternatively include an electrically erasable programmable read-only memory (EEPROM), flash memory or the like.

The memory device 320 may store any of a number of applications or programs which comprise computer-executable instructions/code executed by the processing device 310 to implement the functions of the mobile device 204 described herein. For example, the memory device 320 may include such applications as an AR presentment application 321, object recognition application 325, a web browser application 322, an SMS application 323, an email application 324, etc.

FIG. 4 further illustrates a mobile device 204 wherein the user 202 has executed an object recognition application 325, AR presentment application 321, and a real-time video capture device (e.g., camera 370) is utilized to display the surrounding environment 250 on the display 330 of the mobile device 204. In some embodiments, the mobile device 204, via the object recognition application 325 is configured to utilize markers 230 to identify objects 220, such as goods or businesses, and indicate to the user 202 identified objects 220 by displaying a virtual image 400 on the mobile device display 330. As illustrated in FIG. 4, if an object 220 does not have any markers 230 (or at least enough markers 230 to yield object identification by the object recognition application 325), the object 220 will be displayed without an associated virtual image 400.

The mobile device 204 may use any type of means in order to identify desired objects 220 using the object recognition application 325. For instance, the object recognition application 325 may utilize one or more pattern recognition algorithms to analyze objects in the environment 250 and compare with markers 230 in data storage 371 which may be contained within the mobile device 204 (such as within chip 380) or externally on a separate system accessible via the connected network 201, such as but not limited to the financial institution server 208. For example, the pattern recognition algorithms may include decision trees, logistic regression, Bayes classifiers, support vector machines, kernel estimation, perceptrons, clustering algorithms, regression algorithms, categorical sequence labeling algorithms, real-valued sequence labeling algorithms, parsing algorithms, general algorithms for predicting arbitrarily-structured labels such as Bayesian networks and Markov random fields, ensemble learning algorithms such as bootstrap aggregating, boosting, ensemble averaging, combinations thereof, and the like.

Upon identifying an object 220 within the real-time video stream, the mobile device 204 is configured to superimpose a virtual image 400 on the mobile device display 330 via utilization of the AR presentment application 321. The virtual image 400 is generally a tab or link displayed such that the user 202 may “select” the virtual image 400 and retrieve information related to the identified object. The information may include any desired information associated with the selected object and may range from basic information to greatly detailed information. In some embodiments, the virtual image 400 may provide the user 202 with an internet hyperlink to further information on the object 220. The information may include, for example, all types of media, such as text, images, clipart, video clips, movies, or any other type of information desired. In yet other embodiments, the virtual image 400 information related to the identified object may be visualized by the user 202 without “selecting” the virtual image 400.

In embodiments in which the virtual image 400 provides an interactive tab to the user 202, the user 202 may select the virtual image 400 by any conventional means for interaction with the mobile device 204 through the AR presentment application 321. For instance, in some embodiments, the user 202 may utilize an input device 340 such as a keyboard to highlight and select the virtual image 400 in order to retrieve the information. In a particular embodiment, the mobile device display 330 includes a touch screen that the user 202 may employ to select the virtual image 400 utilizing the user's finger, a stylus, or the like.

In some embodiments, the virtual image 400 is not interactive and simply provides information to the user 202 by superimposing the virtual image 400 onto the display 330. For example, in some instances it may be beneficial for the AR presentment application 321 to merely identify an object 220, just identify the object's name/title, give brief information about the object, etc., rather than provide extensive detail that requires interaction with the virtual image 400. The mobile device 204 is capable of being tailored to a user's desired preferences.

Furthermore, the AR presentment application 321 may allow for the virtual image 400 to be displayed at any size on the mobile device display 330. The virtual image 400 may be small enough that it is positioned on or next to the object 220 being identified such that the object 220 remains discernable behind the virtual image 400. Additionally, the virtual image 400 may be semi-transparent such that the object 220 remains discernable behind the virtual image. In other embodiments, the virtual image 400 may be large enough to completely cover the object 220 portrayed on the display 330. Indeed, in some embodiments, the virtual image 400 may cover a majority or the entirety of the mobile device display 330.

The user 202 may opt to execute the AR presentment application 321 at any desired moment and begin video capture and analysis. However, in some embodiments, the object recognition application 325 and/or the AR presentment application 321 may include an “always on” feature in which the mobile device 204 is continuously capturing video and analyzing the objects 220 within the video stream. In such embodiments, the object recognition application 325 and/or the AR presentment application 321 may be configured to alert the user 202 that a particular object 220 has been identified. The user 202 may set any number of user preferences to tailor the AR experience to his/her needs. For instance, the user 202 may opt to only be alerted if a certain particular object 220 is identified. Additionally, it will be appreciated that the “always on” feature in which video is continuously captured may consume the mobile device power source 315 more quickly. Thus, in some embodiments, the “always on” feature may disengage if a determined event occurs such as low power source 315, low levels of light for an extended period of time (e.g., such as if the mobile device 204 is in a user's pocket obstructing a clear view of the environment 250 from the mobile device 204), if the mobile device 204 remains stationary (thus receiving the same video stream) for an extended period of time, the user 202 sets a certain time of day to disengage, etc. Conversely, if the “always on” feature is disengaged due to the occurrence of such an event, the user 202 may opt for the “always on” feature to re-engage after the duration of the disengaging event (e.g., power source 315 is re-charged, light levels are increased, etc.).

In some embodiments, the user 202 may identify objects 220 that the object recognition application 325 does not identify and add it to the data storage 371 with desired information in order to be identified and/or displayed in the future. For instance, the user 202 may select an unidentified object 220 and enter a name/title and/or any other desired information for the unidentified object 220. In such embodiments, the object recognition application 325 may detect/record certain markers 230 about the object 220 so that the pattern recognition algorithm(s) (or other identification means) may detect the object 220 in the future. Furthermore, in cases where the object information is within the data storage 371, but the object recognition application 325 fails to identify the object 220 (e.g., one or more identifying characteristics or markers 230 of the object has changed since it was added to the data storage 371 or the marker 230 simply was not identified), the user 202 may select the object 220 and associate it with an object 220 already stored in the data storage 371. In such cases, object recognition application 325 may be capable of updating the markers 230 for the object 220 in order to identify the object in future real-time video streams.

In addition, in some embodiments, the user 202 may opt to edit the information or add to the information provided by the virtual object 400. For instance, the user 202 may opt to include user-specific information about a certain object 220 such that the information may be displayed upon a future identification of the object 220. Conversely, in some embodiments, the user 202 may opt to delete or hide an object 220 from being identified and a virtual object 400 associated therewith being displayed on the mobile device display 330.

Furthermore, in some instances, an object 220 may include one or more markers 230 identified by the object recognition application 325 that leads the object recognition application 325 to associate an object with more than one object in the data storage 371. In such instances, the user 202 may be presented with the multiple candidate identifications and may opt to choose the appropriate identification or input a different identification. The multiple candidates may be presented to the user 202 by any means. For instance, in one embodiment, the candidates are presented to the user 202 as a list wherein the “strongest” candidate is listed first based on reliability of the identification. Upon input by the user 202 identifying the object 220, the object recognition application 325 may “learn” from the input and store additional markers 230 in order to avoid multiple identification candidates for the same object 220 in future identifications.

Additionally, the object recognition application 325 may utilize other bases for identification than identification algorithms. For instance, the object recognition application 325 may utilize the user's location, time of day, season, weather, speed of location changes (e.g., walking versus traveling), “busyness” (e.g., how many objects are in motion versus stationary in the video stream), as well any number of other conceivable factors in determining the identification of objects 220. Moreover, the user 202 may input preferences or other metrics for which the object recognition application 325 may utilize to narrow results of identified objects 220.

In some embodiments, once the object is recognized using the object recognition application 325. The AR presentment application 321 provides for superimposed virtual objects 400 or indicators associated with the objects recognized by the object recognition application 325.

In some embodiments, the AR presentment application 321 may have the ability to gather and report user 202 interactions with displayed virtual objects 400. The data elements gathered and reported may include, but are not limited to, number of offer impressions; time spent “viewing” an offer, product, object or business; number of offers investigated via a selection; number of offers loaded to an electronic wallet and the like. Such user 202 interactions may be reported to any type of entity desired. In one particular embodiment, the user 202 interactions may be reported to a financial institution and the information reported may include user 202 financial behavior, purchase power/transaction history, and the like.

In some embodiments, the information provided by the real-time video stream may be compared to data provided to the system through an API. In this way, the data may be stored in a separate application and be implemented by request from the mobile device 204 and/or server.

FIG. 5 illustrates a process map for a providing a target offer using a real-time video stream 500. At block 502 the user 202 enters a business and approaches a product or is on a street and approaches products or businesses. A business may be, but is not limited to, a restaurant, retail store, vendor, shopping mall, warehouse, service provider, Internet store, or any other location where products or services are available. Additionally, a user 202 may see a business while driving down a street, walking, from a window, etc. In additional embodiments, a real-time video stream may be captured from a mobile device 204 affixed to a moving vehicle, such as an automobile or the like, such that as the vehicle moves, real-time video stream is captured including images of the businesses that the vehicle passes. In this way, a user 202 may either enter a business where products or services are located that the user 202 may wish to purchase. Once the user 202 enters the store or passes the business the user 202 may point his/her mobile device at a product or the environment, as shown in block 504.

At block 506 the user 202 may capture images of products or businesses offering services, as part of a real-time video stream. In some embodiments, the user 202 may point his/her mobile device 204 at a product. In other embodiments, the user 202 may point his/her mobile device 204 at a business. Once the user 202 has captured images, the system may receive the information associated with the image 508. The image may be a single frame of video (e.g., a screenshot), an entirety of a video, or any portion in between. Additionally, rather than video, the user 202 may opt to take a still picture of the environment. The image may further comprise of multiple single images compiled together. Once the financial institution application 224 or mobile device 204 receives the information associated with the image, a comparison of the information from the image to identifying data, or a directory, stored in the memory device is performed, as illustrated in block 510. The directory may determine the product and/or business in the image, from the information sent to the system. For example, if the user 202 is walking down a city street and he/she uses real-time video stream to identify a car dealership, the data from the image the user 202 took may provide data to the financial institution application 224 or the mobile device 204 such that the exact car dealership and the vehicles currently available on the lot may be known.

As illustrated in FIG. 5, at block 511 the information from the image is analyzed to a directory in a memory device to determine matches of pre-selected favorites of individuals associated with the user 202 and the user 202. In some embodiments, pre-selected favorites may be provided by the user 202 or individuals associated with the user 202 through the use of an interface (for example, a wish list, grocery list, etc.). The user 202 or individuals associated with the user 202 may “opt-in” to provide pre-selected favorites. In some embodiments, pre-selected favorites may be provided by the user 202 or individuals associated with the user 202 through the use of social networking. In yet other embodiments, the pre-selected favorites may be provided by the user 202 or individuals associated with the user 202 by other communication means such as, but not limited to email message, text message, voice message, video message/conference or the like. In this way, the user 202 or individuals associated with the user 202 may provide the system directory with pre-selected favorites which may be included in the directory for a user 202 to be utilized in connection with the real-time video stream.

At block 512 the information is analyzed for the targeted offers. The targeted offers are based on the pre-selected favorites as illustrated in block 511, the financial behavior of the user 202 or individuals associated with the user 202, and/or recommendations from individuals associated with the user 202 or others. In some embodiments, the system may determine the criteria independent of the user 202.

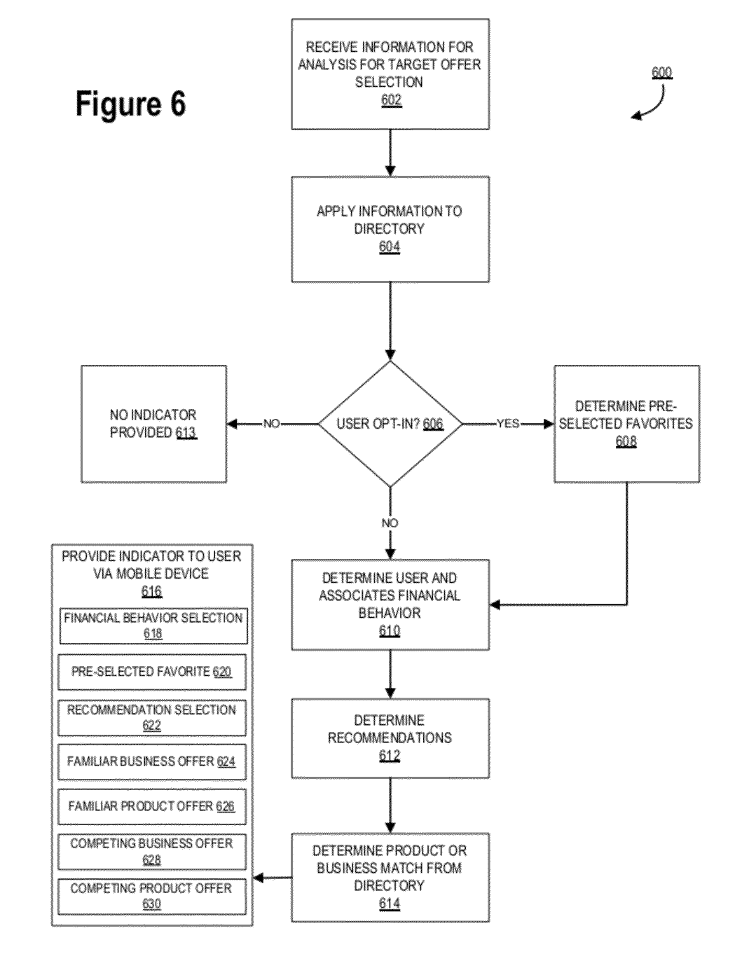

FIG. 6 illustrates the analysis for selecting the targeted offers for a user's possible purchase of a product 600. As illustrated by block 602, the process 600 begins by the system receiving information for analysis for a targeted offer selection from a real-time video stream from a user 202 mobile device 204. Then, as illustrated by block 604, the received information is applied to a directory. The directory contains data regarding a user 202 or individuals associated with a user 202 financial behavior, pre-selected favorites, and/or recommendations. In this way, the directory stores data associated with the products or business that the user 202 may be looking for. For example, a user 202 may be driving down a city street looking for a specific restaurant that was suggested by an individual associated wanted him wants the user 202. Using the directory, the real-time video stream may provide the user 202 with an indicator indicating the location of the specific restaurant the individual associated with the user 202 suggested.

As illustrated by block 606 in FIG. 6, the next step in the analysis 600 is to determine if the user 202 has provided an opt-in function for the targeted offer program. The opt-in function allows a user to opt-in to using pre-selected favorites. If the user 202 does not choose to opt-in to using pre-selected favorites, one of two processes may occur. In some embodiments, if the user 202 does not opt-in, there is no indicator provided to the user when an object 220 is seen through the real-time video stream as illustrated by block 613. In some embodiments, the user 202 may continue in the process so that an indicator may be provided to him/her in block 616.

The user 202 may opt-in by using a pre-selected favorites interface, such as illustrated in FIG. 7, by social networking, by other selection methods which may include, but are not limited to sending a communication via email, text, voice message, video message/conference or like means of selecting an opt-in function.

FIG. 7 illustrates a selection interface 700 in accordance with some embodiments of the invention. If the user 202 has opted-in for the pre-selected favorites the user 202 or individuals associated with the user 202 may provide pre-selected favorites to the directory. Pre-selected favorites may include favorites of the user 202 or individuals associated with the user 202. In one embodiment, pre-selected favorites may be provided to the directory by the user 202 or individual associated with the user 202 by an interface, such as the selection interface 700.

The selection interface 700 may be provided from a financial institution to the mobile device 204 of the user 202 or individual associated with the user 202. The interface may also be provided from a financial institution to the user 202 or individuals associated with the user 202 through online banking means. The user 202 or individual associated with the user 202 may access the interface in any means he/she would typically access online banking. FIG. 7 provides one embodiment of a selection interface that allows a user 202 to opt-in to provide pre-selected favorites to the targeted offer program. The financial institution server 208 receives a request from a user 202 to set up pre-selected favorites. If the user 202 has not already enrolled, the financial institution server 208 may prompt the user 202 to create a new account. As illustrated in the security section 704, the user 202 creates a user name 706 and password 708 for a new account or otherwise logs into the user's pre-selected favorites pool if the user 202 has previously set up a pool. For example, illustrated in FIG. 7 is a selection interface 702 that allows a user 202 to create a log-in name and password to set up a pre-selected favorites pool. In some embodiments, the selection interface 700 requires entering information for security reasons 704. At this point, the user 202 may enter a user name 706, a password 708, and a reply to a security question 710. If the user name 706, password 708, and the reply to a security question 710 are satisfactory, the interface prompts the user to the next step in the process. For example, if the user name 706 is being used by a current user, the new user will be prompted to create a different user name 706. In some embodiments, the user 202 may simply enroll in the pre-selected favorites pool through the user's online banking application. In some embodiments, the interface described herein may be accessed through the object recognition application 325 and/or the AR presentment application 321 using a mobile device 204.

The user 202 may provide information regarding the payment accounts available to him/her, in an account pool, so that his/her financial history may be tracked, in section 712. The types of payment accounts available to the user 202 may include any account the user 202 may use to make a transaction. These accounts may include cash accounts, checking account, a plurality of credit cards or debit cards, a plurality of retailer cards, a plurality of lines of credit, a plurality of gift cards, etc. In the add accounts for transaction review section 712 of the selection interface 700, the user 202 can select the type of account 714 from a menu. The account selections include a credit card 718, a debit card 720, a retail card 722, a line of credit (LOC) 724, a selection to create an account 726, etc. In other embodiments, other accounts may be added to the account pool. In other embodiments, a financial institution may automatically include accounts in the account pool. In one embodiment, the account may be with the financial institution. In one embodiment, the account may be with other financial institutions. In one embodiment, the account may be with an account providing business.

In one embodiment, the accounts available in the account pool may be provided from a financial institution. If the user 202 has prior accounts with the financial institution, the financial institution may recognize the accounts and include them among the accounts in the account pool. Thereafter, the financial institution may continually add additional accounts not already included in the account pool to the pool of the account becomes available at a later date. For example, the user 202 may make a transaction using an account, such as a mobile wallet, a credit card, or other payment system that not linked to a specific account in the account pool. The financial institution server 208, may determine that the account is not a part of the available account pool. The account that the user 202 used for the transaction that is not part of the user's account pool, the financial institution server 208 may add the account to the pool. In this way, products or businesses purchased from the various accounts of the user 202 may be implemented as financial behavior during further real-time video streams.

The create an account selection 726 of the selection interface 700 illustrated in FIG. 7, allows a user 202 to create an account that is not specifically mentioned in the select account type 714 menu. Once a type of account is selected 714, information regarding that account may be inputted in the account information section 716 in order to allow the financial institution to identify the account. In some embodiments, the accounts that can be added to the account pool are all issued by the user's primary financial institution. In other embodiments, the accounts added to the account selection pool may be issued by multiple businesses. The businesses could be any company that provides accounts such as credit cards, retail store cards, or other types of accounts such as lines of credit. For example, the user 202 can add an account that is not issued by the user's primary financial institution, such as a credit card account issued by a specific retailer or a secondary financial institution In such embodiments, the user 202 may need to provide account information in the account information section 716, so that the primary financial institution can access information regarding the account at the secondary financial institution or other business. In some embodiments, the account information section 716 may include a bank section 728, an account number section 730, the expiration date section 732, and the routing number section 734 in order to add accounts to the account pool. In some embodiments, a user name 706 and password 708 may be entered to allow the primary financial institution to access account information located at the other businesses.

Once the information in the account information section 716 is added, the user 202 may select to add that account to the account pool. The accounts that populate the account pool are used by the financial institution application 224 to determine the financial history of the user 202 and individuals associated with the user 202. In this way, the financial institution application 224 may know the products that the user 202 typically purchases by knowing the user's financial history. For example, a user 202 may provide a credit card account to the selection interface 700. The financial institution application 224 may learn that the user 202 or individuals associated with the user 202 or the credit card account, such as a spouse or child, may have purchased a specific brand of shampoo for the last twenty four months. If the user 202 is using his/her mobile device 204 with real-time video steam, an indicator may let the user 202 know the specific brand of shampoo that the account has purchased in the past. Not only will the type of shampoo purchased in the past, be known, but also the size, fragrance, etc. will also be known.

The user 202 may decide to continue and set up his/her pre-selected favorites. The selection interface 700 may provide a favorites section 736 for adding favorite products or business and viewing current favorites. In the add favorites section 738, the user 202 may select the favorites in which he/she or individuals associated with him/her may wish to add to the targeted offer program. The user 202 may add favorites by brand 742 which will allow a user 202 to the brand of a business or product to his/her pre-selected favorites. For example, the spouse of a user 202 may provide the pre-selected favorites a specific brand of soft drink that she always purchases, in this way the user 202 may know the brand of soft drink to purchase. The user 202 may add favorites by product 744. For example, a user 202 may select a pre-selected favorite by inputting a product, such as a computer. The user 202 may add favorites by business 746. For example, a user 202 may be looking for a specific type of store, such as a dry cleaner. he/she may add dry cleaners to his/her pre-selected favorites, such that the system may indicate dry cleaners, even if they are not directly in the real-time video stream environment, but are within a close proximity to the environment. The user 202 may add favorites by creating a new search under the create section 748. In this way, the user 202 or individuals associated with the user may provide new or more refined search criteria to add favorites to the pre-selected favorites pool. The user 202 may also select from a list of recommendations 750. In some embodiments, the recommendations list combines products that the user 202 typically purchases with products that are reviewed for quality. In this way, the user 202 may add to his/her pre-selected favorites, products that he/she may not have purchased yet, but may be interested in purchasing based on the recommendations. In some embodiments, the recommendation list may be provided from the financial institution and data the financial institution acquires. Once the user 202 has selected the product or business by brand 742, by product 744, by business 746, by creating a search 748, or by a recommendation 750 the user 202 may add the product or business to the list of favorites 740, by selecting the add button.

Once the user 202 has completed adding his/her favorites he/she may view the list of favorites he/she has compiled in section 740. The list has a compilation of all favorites that the user 202 has added. The favorites may have been added during a previous log-in session or during the current log-in session. If the user 202 wishes, he/she may remove a product from the list of favorites 740 if it is no longer a favorite to the user 202 or individuals associated with the user. Once the user 202 has completed adding or removing products or business from his/her favorites list, to save data added or removed the user 202 and/or individual associated with the user may select the finish button 752.

Using the interface or other means the user 202 or individuals associated with the user 202 may provide pre-selected favorites to the targeted offer program at any time convenient to the user 202. In this way, the user 202 or individuals associated with the user 202 may provide favorites at any time they have access to online banking. Pre-selected favorites may also be provided by the user 202 or individuals associated with the user 202 by social networks. In this way, the individual may provide a list of products or business he/she recommends on his/her social network page.

Once the that the user 202 has been verified and opted-in, a determination is made regarding the pre-selected favorites, as illustrated in block 608 of FIG. 6. The pre-selected favorites dictionary is compared to the information from the environment of the real-time video stream in such a way to determine if a match between an object 220 of the environment matches a pre-selected favorite. This may be done via the object recognition application 325. Once determination of pre-selected favorites is made, a determination based on user and individuals associated with the user's financial behavior is made in block 610. Here the financial behavior of the user 202 or individuals associated with the user are compared to information received from the real-time video stream. In some embodiments, the financial behavior of the user 202 and/or individuals associated with the user 202 may be provided via an indicator, via the AR presentment application 321. In some embodiments, the financial behavior of the user 202 and/or individuals associated with the user 202 may be provided without an indicator, such as corresponding to the object 220 in an environment 250 without the need for selecting an indicator. Financial behavior provides the means to determine what products were purchased and/or what business those products were purchased from, by the user 202 and/or individuals associated with the user 202. In this way, an indication is provided as to the products purchased, the number of products purchased, the types of products purchased, the business purchased from, and when the purchases were made. Financial behavior may be determined base on criteria such as, but not limited to spending or transaction history, including products acquired; amount spent on products; businesses at which products were acquired; amount spent at specific businesses; how recently products were acquired; how recently a business was used to make a purchase or transaction; spending or transaction patterns, such as time of date/week/month/year for making purchases or transactions; offers used to make purchases or transactions; and the like. The financial behavior data may be determined based on credit, debit, and other demand deposit account purchases/transactions, financial intuitions or the like are in a unique position to have such financial behavior data at their disposal.

As illustrated in block 612 of FIG. 6, the next step is to determine recommendations based on the information in the real-time video stream environment. In some embodiments, recommendations are provided to the user 202 via an indicator. In this way, the user 202 may view recommendations for the product from individuals associated with the user 202 and other individuals who have purchased, reviewed, or commented about the product. The reviews or comments from other individuals who have purchased the product are primarily provided from websites that allow for comment or review. For example, an individual may have purchased a product from a retail store, the individual may not have liked the product and provided feedback regarding the product on the retail store website. The financial institution application 224 may collect the feedback from the retail store website or other websites that the feedback may have been provided to, and provide the feedback to the user 202 for products in the environment of the real-time video stream. Recommendations may be provided by individuals associated with the user 202 or other individuals who have reviewed, commented, provided feedback, or the like for products or business (e.g. services). In some embodiment, recommendations may be provided by individuals associated with the individual or other individuals not associated with the user may be provided via social networking sites. In some embodiments, recommendations may be provided from websites that provide reviews, feedback, and/or comments for individuals who have used and the products. In this way, the directory may pull comments from other individuals, known or not known to the user 202, in order for the user 202 to have a recommendation regarding the products in the real-time video stream if the user 202 so desires.

As illustrated in block 614 of FIG. 6, the next step in analyzing the information for target offer selection is to determine product or business matches from the directory. In this way, the financial institution application 224 and/or the object recognition application 325 may compare the directory to the information received from the real-time video stream to determine of any of the products or businesses in the environment are pre-selected favorites of the user 202 or individuals associated with the user 202, to determine if any products or business in the environment correspond to the financial behavior of the user 202 or individuals associated with the user 202, and/or to determine if any of the products or business in the environment were reviewed by individuals associated with the user 202 or others. The determination of matches between the directory and the information provided by the real-time video stream may, in some embodiments, be determined by the mobile device 204, such as by the object recognition application 325. In other embodiments the determination of matches between the directory and the information provided by the real-time video stream may provided by the financial institution application 224.

With the matches between the directory and the information from the real-time video stream determined in block 614. The user 202 is provided indicators via his/her mobile device in block 616 through the AR presentment application 321. The indicators may provide targeted offers based on the pre-selected favorites, the financial behaviors, and/or the recommendations for products and business found in the directory. In some embodiments, the targeted offer may be provided in real-time in the environment 250 by the indicator 230. In some embodiments, the targeted offer may be provided to the user 202 after the user 202 selects the indicator 230.

The targeted offer indicators may include, but are not limited to financial behavior selection 618, pre-selected favorites 620, recommendation selection 622, familiar business offer 624, familiar product offer 626, competing business offer 628, and competing product offer 630. The financial behavior selection 618 provides the user 202, within a selected indicator, information related to previous transactions made for the product or similar products in the environment.

For example, a user 202 may be in the cereals aisle at a grocery store. When the user 202 uses the real-time video stream an indicator may be provided for a brand A of oat cereal. When he/she selects the indicator for brand A oat cereal, the financial behavior information from the directory may indicate that the user has purchased brand A cereal twice in the last three years, but has purchased brand B oat cereal for the last several years. The pre-selected favorites selection 620 provides the user 202 with information comparing the product in the real-time video stream and pre-selected favorite products or businesses the user 202 or individuals associated with the user. For example, the user's spouse may provide a grocery list for the user 202 to purchase at the grocery store. When the user 202 is in the cereal aisle he/she may use the real-time video stream to scan the aisle, the cereals that are listed on the pre-selected favorites previously provided by the spouse of the user 202 may show an extra indicator when scanning the aisle. The recommendation selection 662 provides the user 202 selected indicator information relating to comments, feedback, ratings, etc. that individuals associated with the user or others may have provided. In this way, the user 202 may be provided instant ratings for the products in the user's environment. For example, the user 202 may be shopping for a new television at a retail store. The user 202 may use real-time video stream to provide indicators of recommendations. In this way the user 202 may see recommendations, comments, feedback, ratings, etc. that others have provided for the television. This way the user 202 may make an informed purchase based on up to the minute recommendations, ratings, comments, etc.

A user 202 may also be presented with offers in the indicator provided to the user via the mobile device 616. Offers may be in the form of familiar business offers 624, familiar product offers 626, competing business offers 628, and/or competing product offers 630. These offers may be in the form of special offers for the user 202 of the mobile device 204, such as a discount, coupon, etc. that may expire within a predetermined amount of time or may be available to the user 202 at any time he/she wishes to make a transaction. The special offers may also be contingent on opening accounts or other lines of business with the financial institution, independent of the transaction. Special offers may be discounts that the business or product manufacturer may provide to other customers. Special offers may also be discount provided specifically to users 202 of the targeted offer program. These offers may be based on the user 202 pre-selecting the product, the user 202 purchasing the product several times in the past (financial behavior), points for purchasing, life event triggers special offers (for example, financial transaction recently for diapers may indicate birth of a child), or the special offer may be because the retailer or manufacturer is able to provide the offer because of the financial institutions commercial partnership with the business. In some embodiments, the user 202 may be provided with several different special offers within each indicator. For example, a user 202 may be provided a familiar business offer, a familiar product offer, a competing business offer, and a competing product offer.

Familiar business offers 624 may be special offers for use at the business or near the business location from which the user 202 is obtaining the real-time video stream. In this way, the user 202 may be provided special offers for services of the businesses that he/she is currently visiting. Familiar product offers 626 may be special offers for use for the product or a familiar product that the user 202 is obtaining the real-time video stream. In this way, the user 202 may be provided special offers for the product within the environment he/she is currently viewing, obtained by real-time video stream. Competing business offers 628 may be special offers for use at a competing business, other than the one that the user 202 is obtaining through the real-time video stream. In this way, the user 202 may be provided special offers for businesses that are in competition with the business from whom the user 202 is gathering the real-time video stream. For example, the user 202 may be obtaining real-time video stream of one coffee shop, but a special offer for a similar type of coffee shop may be provided. This way the user 202 may be alerted of the opportunity to visit a new coffee shop that provides the user 202 with a special offer and not the coffee shop that is in the mobile device 204 environment. Competing product offers 630 may be special offers for use with a competing product, other than the one that the user 202 is obtaining through the real-time video stream. In this way, the user 202 may be provided special offers for products in competition with the products in the user's real-time video stream.

As further detailed in FIG. 5, once the information is analyzed for targeted offers in block 512, in decision block 514, a determination is made as to whether the mobile device is still capturing video stream of a product and/or business. If no video stream is being captured then no indicator is presented in block 516. If a video stream is still being captured, then in block 518 indicators are continuing to be presented with respect to financial behavior and/or pre-selected favorites. The indicators are associated with a product and/or business that the user 202 may visualize in an environment 250. In some embodiments, the user 202 may be provided a targeted offer prior to selecting an indication. In some embodiments, as illustrated in block 520, a user may receive a targeted offer after the user 202 selects the indicator.

If the user 202 selects the indicator in block 520, the user 202 is provided further detail about the product and special offers available for that product or business (or a competing product or business). The selected indicator may provide more detailed information with respect to the financial behavior and pre-selected favorites. For example, the detailed information for the financial behavior may provide the user 202 with the exact number of times the user 202 has purchased the product in the last year.

As further illustrated in FIG. 5 at block 522 a user 202 may purchase a product based on the targeted offer information. In various embodiments, information associated with or related to one or more objects that is retrieved for presentation to a user 202 via the mobile device 204 may be permanently or semi-permanently associated with the object 220. In other words, the object 220 may be “tagged” with the information. In some embodiments, a location pointer is associated with an object after information is retrieved regarding the object. In this regard, subsequent mobile devices capturing the object for recognition may retrieve the associated information, tags and/or pointers in order to more quickly retrieve information regarding the object. In some embodiments, the mobile device 204 provides the user 202 an opportunity to post messages, links to information or the like and associate such postings with the object. Subsequent users may then be presenting such postings when their mobile devices capture and recognize an object. In some embodiments, the information gathered through the recognition and information retrieval process may be posted by the user 202 in association with the object. Such tags and/or postings may be stored in a predetermined memory and/or database for ease of searching and retrieval.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, etc.) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

Thus, methods, systems, computer programs and the like have been disclosed that provide for using real-time video analysis, such as AR or the like to assist the user of mobile devices with commerce activities. Through the use real-time vision object recognition objects, logos, artwork, products, locations and other features that can be recognized in the real-time video stream can be matched to data associated with such to assist the user with commerce activity. The commerce activity may include, but is not limited to; conducting a transaction, providing information about a product/service, providing rewards based information, providing user-specific offers, or the like. In specific embodiments, the data that matched to the images in the real-time video stream is specific to financial institutions, such as user financial behavior history, user purchase power/transaction history and the like. In this regard, many of the embodiments herein disclosed leverage financial institution data, which is uniquely specific to financial institution, in providing information to mobile devices users in connection with real-time video stream analysis.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

The systems, methods, computer program products, etc. described herein, may be utilized or combined with any other suitable AR-related application. Non-limiting examples of other suitable AR-related applications include those described in the following U.S. Provisional Patent Applications, the entirety of each of which is incorporated herein by reference:

| U.S. | | |
|---|---|---|
| Provisional | | |
| Ser. No. | Filed On | Title |
| 61/450,213 | Mar. 8, 2011 | Real-Time Video Image Analysis |
| | | Applications for Commerce Activity |
| 61/478,409 | Apr. 22, 2011 | Presenting Offers on a Mobile |
| | | Communication Device |
| 61/478,412 | Apr. 22, 2011 | Real-Time Video Analysis for Reward |
| | | Offers |
| 61/478,399 | Apr. 22, 2011 | Real-Time Analysis Involving Real Estate |
| | | Listings |
| 61/478,402 | Apr. 22, 2011 | Real-Time Video Image Analysis for an |
| | | Appropriate Payment Account |
| 61/478,405 | Apr. 22, 2011 | Presenting Investment-Related Information |
| | | on a Mobile Communication Device |
| 61/478,393 | Apr. 22, 2011 | Real-Time Image Analysis for Medical |
| | | Savings Plans |
| 61/478,397 | Apr. 22, 2011 | Providing Data Associated With |
| | | Relationships Between Individuals and |
| | | Images |
| 61/478,408 | Apr. 22, 2011 | Identifying Predetermined Objects in a |
| | | Video Stream Captured by a Mobile |
| | | Device |
| 61/478,400 | Apr. 22, 2011 | Real-Time Image Analysis for Providing |
| | | Health Related Information |
| 61/478,411 | Apr. 22, 2011 | Retrieving Product Information From |
| | | Embedded Sensors Via Mobile Device |
| | | Video Analysis |
| 61/478,403 | Apr. 22, 2011 | Providing Social Impact Information |
| | | Associated With Identified Products or |
| | | Businesses |
| 61/478,407 | Apr. 22, 2011 | Providing Information Associated With an |
| | | Identified Representation of an Object |
| 61/478,415 | Apr. 22, 2011 | Providing Location Identification of |
| | | Associated Individuals Based on |
| | | Identifying the Individuals in Conjunction |
| | | With a Live Video Stream |
| 61/478,419 | Apr. 22, 2011 | Vehicle Recognition |
| 61/478,417 | Apr. 22, 2011 | Collective Network of Augmented Reality |
| | | Users |
| 61/508,985 | Jul. 18, 2011 | Providing Information Regarding Medical |
| | | Conditions |
| 61/508,946 | Jul. 18, 2011 | Dynamically Identifying Individuals From |
| | | a Captured Image |
| 61/508,980 | Jul. 18, 2011 | Providing Affinity Program Information |
| 61/508,821 | Jul. 18, 2011 | Providing Information Regarding Sports |
| | | Movements |
| 61/508,850 | Jul. 18, 2011 | Assessing Environmental Characteristics |
| | | in a Video Stream Captured by a Mobile |
| | | Device |
| 61/508,966 | Jul. 18, 2011 | Real-Time Video Image Analysis for |
| | | Providing Virtual Landscaping |
| 61/508,969 | Jul. 18, 2011 | Real-Time Video Image Analysis for |
| | | Providing Virtual Interior Design |
| 61/508,971 | Jul. 18, 2011 | Real-Time Video Image Analysis for |
| | | Providing Deepening Customer Value |
| 61/508,764 | Jul. 18, 2011 | Conducting Financial Transactions Based |
| | | on Identification of Individuals in an |
| | | Augmented Reality Environment |
| 61/508,973 | Jul. 18, 2011 | Real-Time Video Image Analysis for |
| | | Providing Security |
| 61/508,976 | Jul. 18, 2011 | Providing Retail Shopping Assistance |
| 61/508,944 | Jul. 18, 2011 | Recognizing Financial Document Images |

What is claimed is:

1. A method for providing offers that are associated with products, comprising:
building a directory of data relating to products, the directory further comprising data relating to user product preferences, previous product purchases, and/or product recommendations;
identifying, via a computer device processor, one or more products proximate in location to a mobile device;
recognizing the one or more products proximate in location to the mobile device as a products in the directory;
matching the recognized one or more products with offers associated with the product; and
presenting, via the mobile device of the user, an indicator associated with the product based on the recognition of the one or more products within the directory.

2. The method of claim 1, wherein the directory comprises manually inputted list data, wherein the list data indicates user products preferences.

3. The method of claim 1, wherein previous product purchases are provided by financial institution recognition of user purchase history.

4. The method of claim 1, wherein identifying products further comprises capturing, via the mobile device, images of the one or more products.

5. The method of claim 4, wherein capturing images further comprises implementing object recognition processing to identify one or more images that correspond to one or more products.

6. The method of claim 1, wherein identifying products further comprises capturing real-time imaging of the one or more products.

7. The method of claim 1, wherein identifying products further comprises determining a location of the mobile device and determining, the one or more products based on the determined location.

8. The method of claim 1, wherein presenting an indicator associated with the product comprises displaying the indicator on a display of the mobile device.

9. The method of claim 1, wherein presenting an indicator associated with the product comprises superimposing the indicator over real-time video that is captured by the mobile device.

10. The method of claim 1, wherein the indicator is selectable by the user.

11. The method of claim 1, wherein the indicator, upon being selected, provides recognition of a product based on the directory wherein the directory is based at least in part on products the user has previous purchases.

12. The method of claim 1, wherein the indicator, upon being selected, provides recognition of a product based on the directory wherein the directory is based at least in part on manually inputted user product preferences.

13. The method of claim 1, wherein the indicator, upon being selected, provides a promotional offer for purchase of the product.

14. The method of claim 1, further comprising determining that the mobile device is capturing a real-time video stream comprising a depiction of the product prior to presenting the indicator associated with the product.

15. A system for providing offers that are associated with products, comprising:
a memory device;
a communication device;
a processing device operatively coupled to the memory device and the communication device, wherein the processing device is configured to execute computer-readable program code to:
build a directory of data relating to products, the directory further comprising data relating to user product preferences, previous product purchases, and/or product recommendations;
identify one or more products proximate in location to a mobile device;
recognize the one or more products proximate in location to the mobile device as a products in the directory;
match the recognized one or more products with offers associated with the product; and
present, via the mobile device of the user, an indicator associated with the product based on the recognition of the one or more products within the directory.

16. The system of claim 15, wherein the directory comprises manually inputted list data, wherein the list data indicates user products preferences.

17. The system of claim 15, wherein previous product purchases are provided by financial institution recognition of user purchase history.

18. The system of claim 15, wherein identifying products further comprises capturing, via the mobile device, images of the one or more products.

19. The system of claim 18, wherein capturing images further comprises implementing object recognition processing to identify one or more images that correspond to one or more products.

20. The system of claim 15, wherein identifying products further comprises capturing real-time imaging of the one or more products.

21. The system of claim 15, wherein identifying products further comprises determining a location of the mobile device and determining, the one or more products based on the determined location.

22. The system of claim 15, wherein presenting an indicator associated with the product comprises displaying the indicator on a display of the mobile device.

23. The system of claim 15, wherein presenting an indicator associated with the product comprises superimposing the indicator over real-time video that is captured by the mobile device.

24. The system of claim 15, wherein the indicator is selectable by the user.

25. The system of claim 15, wherein the indicator, upon being selected, provides recognition of a product based on the directory wherein the directory is based at least in part on products the user has previous purchases.

26. The system of claim 15, wherein the indicator, upon being selected, provides recognition of a product based on the directory wherein the directory is based at least in part on manually inputted user product preferences.

27. The system of claim 15, wherein the indicator, upon being selected, provides a promotional offer for purchase of the product.

28. The system of claim 15, further comprising determining that the mobile device is capturing a real-time video stream comprising a depiction of the product prior to presenting the indicator associated with the product.

29. A computer program product for providing offers that are associated with products, the computer program product comprising at least one non-transitory computer-readable medium having computer-readable program code portions embodied therein, the computer-readable program code portions comprising:
an executable portion configured for building a directory of data relating to products, the directory further comprising data relating to user product preferences, previous product purchases, and/or product recommendations;
an executable portion configured for identifying one or more products proximate in location to a mobile device;
an executable portion configured for recognizing the one or more products proximate in location to the mobile device as a products in the directory;
an executable portion configured for matching the recognized one or more products with offers associated with the product; and
an executable portion configured for presenting, via the mobile device of the user, an indicator associated with the product based on the recognition of the one or more products within the directory.

30. The computer program product of claim 29, wherein the directory comprises manually inputted list data, wherein the list data indicates user products preferences.

31. The computer program product of claim 29, wherein previous product purchases are provided by financial institution recognition of user purchase history.

32. The computer program product of claim 29, wherein identifying products further comprises capturing, via the mobile device, images of the one or more products.

33. The computer program product of claim 32, wherein capturing images further comprises implementing object recognition processing to identify one or more images that correspond to one or more products.

34. The computer program product of claim 29, wherein identifying products further comprises capturing real-time imaging of the one or more products.

35. The computer program product of claim 29, wherein identifying products further comprises determining a location of the mobile device and determining, the one or more products based on the determined location.

36. The computer program product of claim 29, wherein presenting an indicator associated with the product comprises displaying the indicator on a display of the mobile device.

37. The computer program product of claim 29, wherein presenting an indicator associated with the product comprises superimposing the indicator over real-time video that is captured by the mobile device.

38. The computer program product of claim 29, wherein the indicator is selectable by the user.

39. The computer program product of claim 29, wherein the indicator, upon being selected, provides recognition of a product based on the directory wherein the directory is based at least in part on products the user has previous purchases.

40. The computer program product of claim 29, wherein the indicator, upon being selected, provides recognition of a product based on the directory wherein the directory is based at least in part on manually inputted user product preferences.

41. The computer program product of claim 29, wherein the indicator, upon being selected, provides a promotional offer for purchase of the product.

42. The computer program product of claim 29, further comprising determining that the mobile device is capturing a real-time video stream comprising a depiction of the product prior to presenting the indicator associated with the product.
